(19) United States
(12) Patent Application Publication
(10) Pub. No.: US 2026/0287440 A1
(43) Pub. Date: Sep. 24, 2026

(54) HOLEY SILICON-BASED THERMOPILES FOR HIGH-SENSITIVITY BROADBAND THERMAL DETECTION

(71) Applicant: The Regents of the University of California, Oakland, CA (US)

(72) Inventors: Jiahui Cao, Irvine, CA (US); Jaeho Lee, Irvine, CA (US)

(21) Appl. No.: 19/476,381

(22) PCT Filed: Jun. 14, 2024
(86) PCT No.: PCT/US24/34065

§ 371 Date: Oct. 17, 2025

Related U.S. Application Data
(60) Provisional application No. 63/509,925, filed on Jun. 23, 2023.

(51) Int. Cl. G01K 7/04

(52) U.S. Cl. CPC G01K 7/04

(57) ABSTRACT

A holey silicon-based thermopile for temperature measurement across an entire electromagnetic spectrum. The thermopile includes a substrate and a cavity formed by the substrate. The thermopile further includes a thermally isolated absorber disposed over the cavity, configured to accept an input radiation reading and output a heat signal and an array of thermocouples configured to connect the thermally isolated absorber to the substrate. The array of thermocouples includes a plurality of silicon structures, each silicon structure having a hole pattern made up of a plurality of holes disposed through the silicon structure. The thermally isolated absorber is suspended, over the cavity by the array of thermocouples. The thermopile further includes a temperature difference transducer operatively coupled to the thermally isolated absorber, configured to convert the heat signal into an electrical voltage signal.

### CROSS-REFERENCES TO RELATED APPLICATIONS

This application claims benefit of U.S. Provisional Application No. 63/509,925 filed Jun. 23, 2023, the specification of which is incorporated herein in its entirety by reference.

### FIELD OF THE INVENTION

The present invention is directed to a thermopile (thermal detector) configured to measure the temperature change of an element through the absorption of electromagnetic radiation and features non-contact temperature measurement under the principle of the Seebeck effect.

### BACKGROUND OF THE INVENTION

Future planetary missions call for thermal detectors that can measure not only hot but also cold objects with high sensitivity over a wide range of temperatures. For instance, ice giant planets such as Uranus and Neptune or icy regolith at the lunar poles may require measurements of cold objects with temperatures below 60 K, in which much of thermal emission takes place at wavelengths greater than 50 μm according to Wien's displacement law. However, conventional approaches based on photon detectors are limited to a narrow and material-selective range of wavelengths and require active cooling for measurements of long-wavelength radiation. To measure thermal emission at wavelengths 50 μm and greater, photon detectors must be cryogenically cooled below 10 K, which results in a significant increase in size, weight, and power (SWaP).

On the other hand, thermal detectors based on thermopiles are sensitive to a wide range of wavelengths including far-infrared radiation, and do not require active cooling or cryogenic operations. While thermopiles are favorable for measurements of long-wavelength radiation or thermal emission by cold objects, their detectivity is limited by the material's thermoelectric response and heat losses.

### BRIEF SUMMARY OF THE INVENTION

It is an objective of the present invention to provide devices that allow for a thermopile (thermal detector) configured to measure the temperature change of an element through the absorption of electromagnetic radiation and features non-contact temperature measurement under the principle of the Seebeck effect, as specified in the independent claims. Embodiments of the invention are given in the dependent claims. Embodiments of the present invention can be freely combined with each other if they are not mutually exclusive.

The present invention features a highly-sensitive broadband thermal detector for hot and cold objects in space using a novel thermopile technology based on holey silicon. Holey silicon is a thin membrane of silicon with a microfabricated arrangement of pores that can be optimized to minimize heat losses and enable breakthrough performance. Furthermore, the proposed use of silicon for thermopiles instead of bismuth telluride compounds offers significant advantages with ease of fabrication, packaging, and compatibility, which allows efficient and reliable processing. The outcomes of the project enable a novel instrument that measures objects over a wide range of temperatures with unprecedentedly high sensitivity and detects even faint thermal signals from temperatures down to 30 K or wavelengths up to 100 μm and enables planetary studies of very cold objects that are not accessible by current instruments. The present invention may lead to breakthrough scientific discoveries in the future by allowing a deeper look at cold objects, and these findings could help scientists discover new information about the ice giants.

The present invention features a holey silicon-based thermopile for temperature measurement across an entire electromagnetic spectrum. In some embodiments, the thermopile may comprise a substrate. A cavity may be formed by the shape of the substrate. The thermopile may further comprise a thermally isolated absorber disposed over the cavity of the substrate, configured to accept an input radiation reading and output a heat signal, and an array of thermocouples configured to connect the thermally isolated absorber to the substrate, the array of thermocouples comprising a plurality of silicon structures, each silicon structure having a hole pattern comprising a plurality of holes disposed through the silicon structure. The thermally isolated absorber may be suspended over the cavity by the array of thermocouples. The thermopile may further comprise a temperature difference transducer operatively coupled to the thermally isolated absorber, configured to convert the heat signal into an electrical voltage signal.

Holey silicon-based thermopiles can be designed to address the sensitivity requirements for both hot and cold objects across the whole electromagnetic spectrum, with a special emphasis on the far-infrared radiation by cold objects in space. The major aspect of the invention is to replace the combined use of bismuth telluride (BiTe)-based thermocouples and silicon nitride (SiN) support beams with holey silicon thermocouples that provide excellent thermal, electrical, and mechanical properties on their own without requiring additional support beams. Compared to previous thermopile designs, the present design is expected to outperform the state-of-the-art by significant margins. In terms of the specific detectivity (D*), a representative figure of merit capturing the signal-to-noise ratio, the holey silicon-based thermopile can be 9 times better than the previously flown instruments (MCS®, Diviner®) and 4 times better than the state-of-art instrument (PREFIRE) that was launched in 2024. The improvement is more significant when compared to existing commercial thermal detectors such as bolometers and pyroelectric sensors.

The holey silicon-based thermopiles enable breakthroughs in spectroscopy and multispectral measurements and allow studies of planetary bodies that radiate in the solar to thermal transition zones (λ~3-8 microns) where there is little solar reflectance or thermal emission. The high-sensitivity instrument could also help multispectral measurements with narrower passbands at low temperatures. The spectral passbands for Diviner® were chosen in part to provide a good signal-to-noise ratio (SNR) for moderate temperatures (~225-250K+). More sensitive pixels mean the bands could be narrower and more compositional information could be conveyed. Furthermore, high-sensitivity instruments could enable faster integration for exceptionally cold scenes. This is particularly important for a compact imager that could be worm by an astronaut and provide real-time temperature readings inside a PSR at 30-40 K. The limited sensitivity in previously flown instruments such as Diviner® has demonstrated significant challenges with real-time images or videos because of the long integration time that required a couple of minutes.

With significant improvements in detectivity and integration time, it is expected that the holey Si-based thermopile will have wider applications for temperature sensing of dynamic objects and small objects. For instance, thermal detectors are widely used in the medical industry to monitor patients' surface temperature and identify signs of syndromes. With improved accuracy and processing time, the detector can now be integrated into autonomous health checkpoints in airports or crowded workplaces that have a dense and rapid flow of population.

One of the unique and inventive technical features of the present invention is the implementation of holey silicon structures for thermal coupling an absorber to a substrate. Without wishing to limit the invention to any theory or mechanism, it is believed that the technical feature of the present invention advantageously provides for low thermal conductivity depending on the size and arrangement of holes, resulting in a significant reduction in thermal conductance and higher detectivity of temperature. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a schematic of the holey silicon-based thermopile of the present invention.

FIG. 2 shows a top-down view of the schematic of FIG. 1, showing the holey silicon structures suspending the absorber over the cavity.

FIG. 3A shows a process of developing and assembling the thermopile of the present invention.

FIG. 3B shows a temperature range detectable by the thermopile of the present invention.

FIG. 4A shows a holey silicon structure and its pitch (P), neck (n), porosity (φ), and thickness (t) that govern thermal, electrical, and thermoelectric properties,

FIGS. 4B-4C show SEM images of holey silicon structures implemented in the present invention.

FIG. 4D shows a diagram of a holey silicon-based thermopile array. The use of holey silicon for temperature sensing in thermopiles enables innovative design and performance.

FIG. 5 shows an example of holey silicon thermocouples that provide excellent thermal, electrical, and mechanical properties on their own without requiring additional support beams.

FIG. 6A shows a graph of size and porosity effects on the effective thermal conductivity of Holey Si.

FIG. 6B shows a graph of conductive and radiative thermal conductance of holey Si-based thermopile versus porosity.

FIG. 7A shows a graph of predicted thermopile-specific detectivity versus thermal conductance. The reference point, 10°, on the x-axis corresponds to the total thermal conductance of a poly-Si-based thermopile. The scatter point corresponds to the PREFIRE detector. The shaded area shows all the possible D* values using the holey silicon membrane from FIG. 6B.

FIG. 7B shows a graph of the effect of operating temperature on specific detectivity.

FIG. 8A shows a diagram of a ray tracing simulation domain displaying possible phonon interactions with various scattering mechanisms; the boundary conditions for the periodic unit cell containing the pore are illustrated to show the phonon-boundary interaction at the pore surface.

FIG. 8B shows holey Si structures with various pore arrangements, which can be engineered to optimize thermopile performance.

FIG. 9A shows an in-plane thermal conductivity measurement device is based on two suspended membranes of electrical coils that sustain a temperature gradient (Tₕ-Tₛ) and a heat flow (q″) across a material of interest.

FIG. 9B shows a holey silicon nanostructure transferred onto the measurement device by an Omni-probe®

FIG. 10 shows a diagram of an on-substrate Seebeck coefficient measurement design using microfabricated electrodes and an infrared camera.

### DETAILED DESCRIPTION OF THE INVENTION

Following is a list of elements corresponding to a particular element referred to herein:
100 thermopile
110 substrate
115 cavity
120 absorber
130 silicon structures
140 transducer

The term “hole pattern” is defined herein as an arrangement of holes disposed on and/or through a surface, characterized by the number of holes, the size of the holes, the spacing between the holes, the shape of the holes, the depth of the holes, or a combination thereof.

The term “series array” is defined herein as a plurality of objects (e.g. thermocouples) arranged in a successive order (e.g. in a line).

The term “Seebeck effect” is defined herein as a phenomenon in which a temperature difference between two dissimilar electrical conductors or semiconductors produces a voltage difference between the two substances.

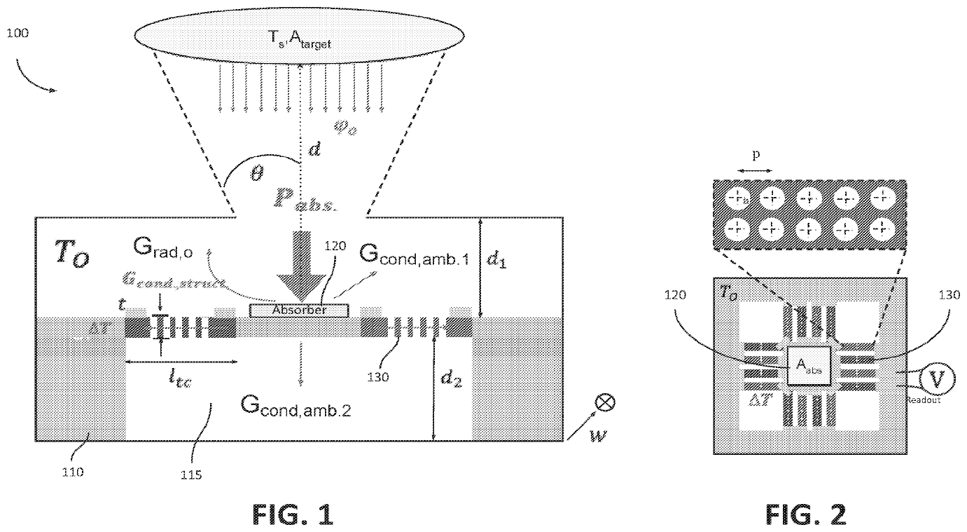

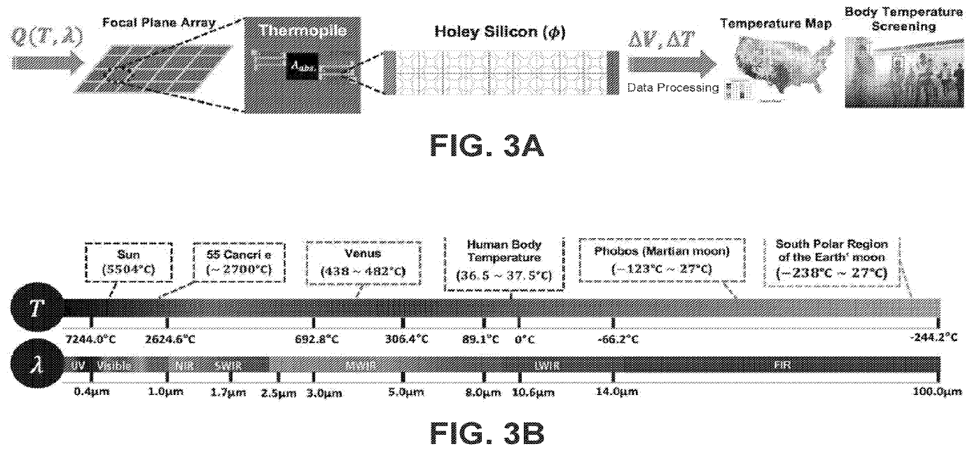

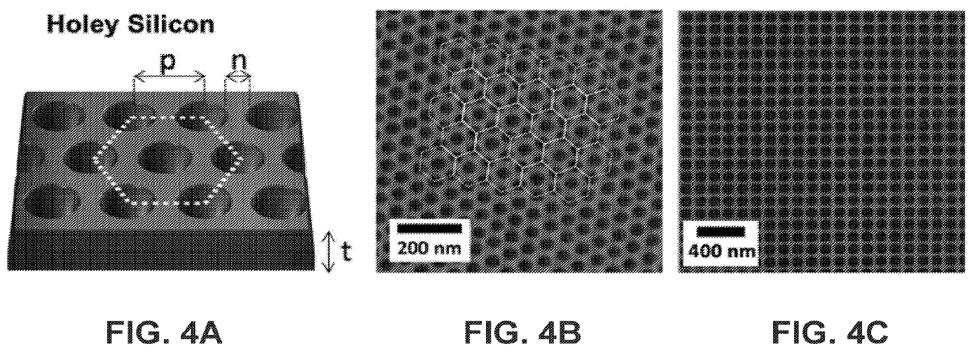

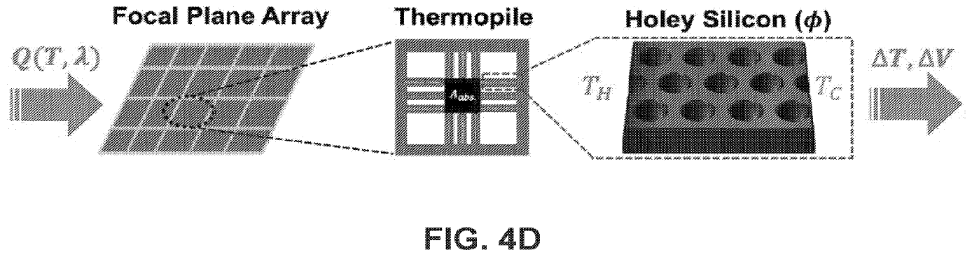

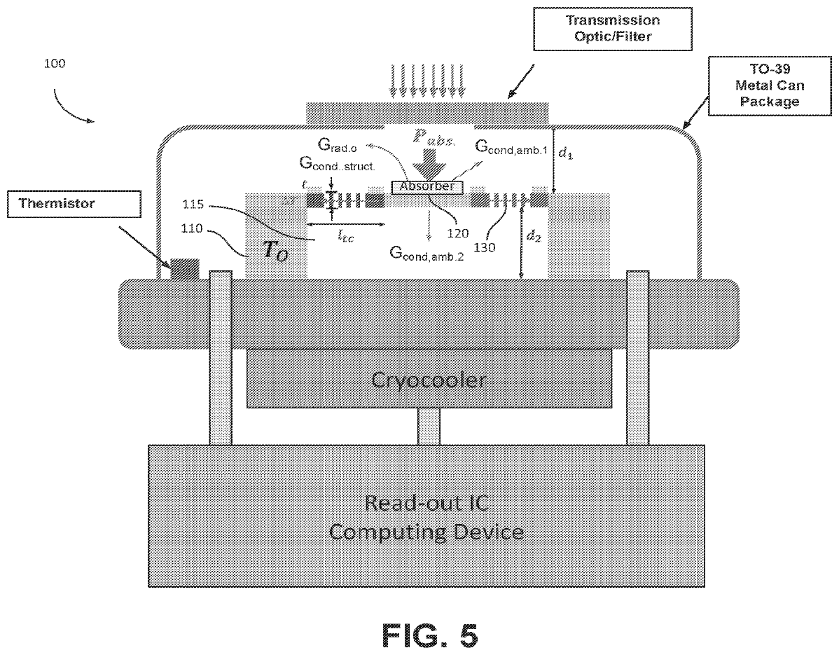

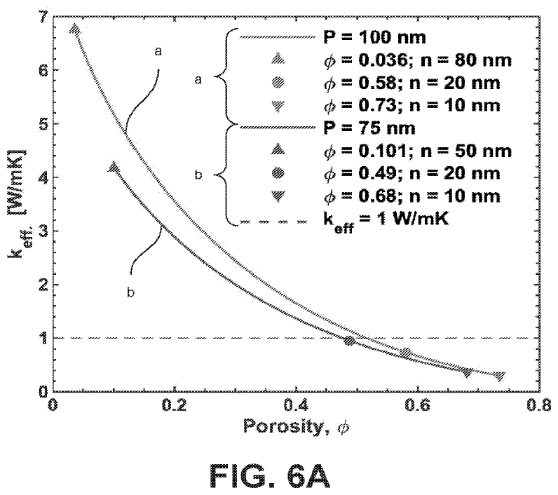

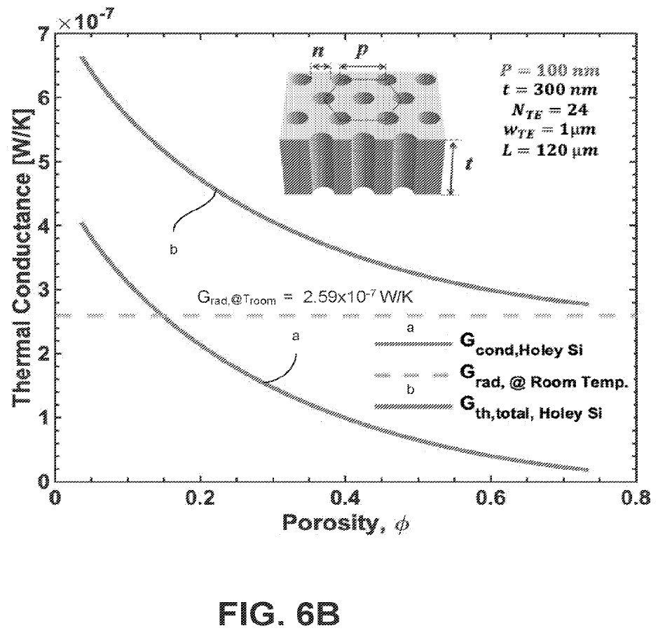

Referring now to FIG. 1, the present invention features a holey silicon-based thermopile (100) for temperature measurement across an entire electromagnetic spectrum. In some embodiments, the thermopile (100) may comprise a substrate (110). A cavity (115) may be formed by the shape of the substrate (110). The thermopile (100) may further comprise a thermally isolated absorber (120) disposed over the cavity (115) of the substrate (110), configured to accept an input radiation reading and output a heat signal, and an array of thermocouples (130) configured to connect the thermally isolated absorber (120) to the substrate (110), the array of thermocouples (130) comprising a plurality of silicon structures, each silicon structure having a hole pattern comprising a plurality of holes disposed through the silicon structure. The thermally isolated absorber (120) may be suspended over the cavity (115) by the array of thermocouples (130). The thermopile (100) may further comprise a temperature difference transducer (140) operatively coupled to the thermally isolated absorber (120), configured to convert the heat signal into an electrical voltage signal. In some embodiments, one or more silicon structures of the plurality of silicon structures may act as the temperature difference transducer (140). The temperature difference developed across the thermocouples may be transduced into electrical potential difference via the Seebeck effect.

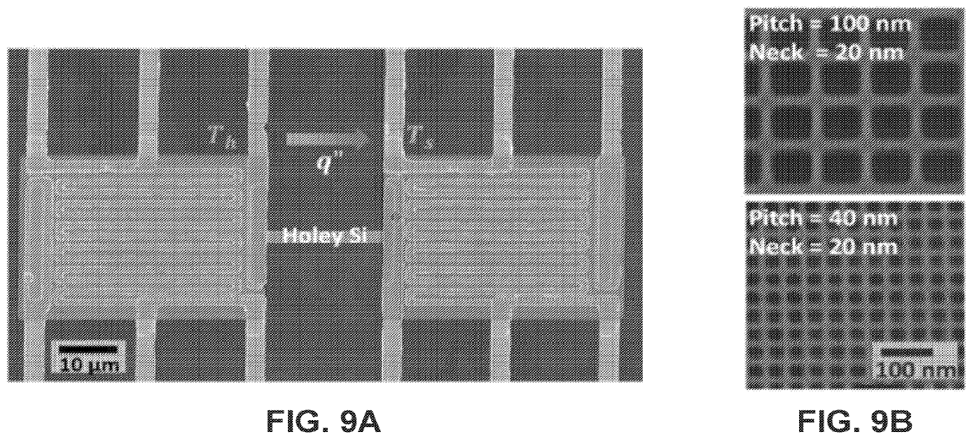

In some embodiments, the hole pattern of each silicon structure comprises a uniform pattern having a plurality of holes grouped by the diameter of each hole. In other embodiments, the hole pattern of each silicon structure comprises an alternating pattern having a first set of holes and a second set of holes interdigitatably disposed between the first set of holes. The first set of holes and the second set of holes may differ in diameter, as depicted in FIG. 9. In some embodiments, the hole pattern of each silicon structure may comprise holes having a circular shape, a rectangular shape, an ellipsoid shape, a diamond shape, a meniscus shape, or a combination thereof. In some embodiments, a material of the substrate (110) comprises silicon, silicon dioxide, or a combination thereof.

Thermopiles have small instrument sizes, weights, and power (SWaP) and high broadband radiometric performance that make them suitable for various applications. They are insensitive to instrument temperature drifts and highly linear to incident radiation. They have negligible 1/f noise and an optimal pixel size that is greater than that of bolometers Yet, the thermopile performance metrics strongly depend on heat losses through materials or their thermal conductivity. The unique advantage of holey silicon is the low thermal conductivity that is strongly dependent on the size and the pore arrangement. By replacing the conventional combination of bismuth telluride (BiTe)-based thermocouples and silicon nitride (SiN) support beams with holey silicon thermocouple beams, a significant reduction in thermal conductance is achievable by unique interactions between phonons and boundaries that are defined by nanoscale pore designs. The low thermal conductance may lead to a significant temperature rise across the thermocouple, which results in responsivity and hence a high detectivity.

In some embodiments, the hole pattern comprises holes with diameters ranging from 20 to 150 nm, separated by neck sizes of 10 to 40 nm. In some embodiments, the absorber may be suspended over the cavity of the substrate by 1 to 16 holey silicon-based thermocouples. In some embodiments, the absorber may be suspended over the cavity by 1 to 16 thermocouple arms, each arm comprising one or more thermocouples. In some embodiments, the absorber is 50 to 200 by 50 to 200 nm in length and width. In some embodiments, the present invention is capable of detecting temperatures of about 30K or less. In some embodiments, the device of the present invention is capable of detecting the temperature of objects with a field of view (FOV) up to 180°. In some embodiments, the absorber can be made of gold-black, impedance-matched metallic thin film, or carbon nanotubes. In some embodiments, a material of the substrate may comprise silicon dioxide or silicon nitride.

In some embodiments, the device of the present invention may further comprise a cryocooler operatively coupled to the substrate. The cryocooler may be configured to cool the device through the substrate to achieve a lower noise level.

### Example

The following is a non-limiting example of the present invention. It is to be understood that said example is not intended to limit the present invention in any way. Equivalents or substitutes are within the scope of the present invention.

To develop a reliable thermal detector, the present invention benchmarked the established design and system-level understanding from the state-of-the-art thermopile technology such as the Polar Radiant Energy in the Far-InfraRed Experiment (PREFIRE), in which a thermopile consists of a thermally isolated absorber and a series array of thermocouples connecting the absorber to a substrate. Since the thermopile performance metrics strongly depend on the materials' heat losses or their thermal conductivity, the present invention implemented holey silicon in the place of conventional thermocouple materials that are based on bismuth-tellurium (BiTe) compounds. The unique advantage of holey silicon was in its low thermal conductivity which was strongly dependent on the size and the pore arrangement. With holey silicon, a significant reduction in thermal conductance was possible by unique interactions between phonons and boundaries that are defined by nanoscale pore designs. Advanced computational and experimental techniques were used to establish a new understanding of phonon transport in holey silicon, identify mechanisms to minimize the thermal conductivity without sacrificing the electrical conductivity or Seebeck coefficient, and demonstrate their impact on thermopile technology.

The thermopile responsivity was defined as the output voltage signal of the detector produced in response to a given incident radiative power falling on the absorber,

$${R}_{s} = {V}_{out} / {P}_{rad} = \frac{η N ( {α}_{p} - {α}_{n} )}{{G}_{th} ( ϕ ) \sqrt{1 + ( 2 π f τ )}} ,$$

where η was the absorption efficiency, N was the total number of thermocouples/thermoelectric lines, α was the Seebeck coefficient, f was the operational frequency, τ was the thermal response time, and Gₜₕ was the thermal conductance, which depended on geometry, thermal conductivity (k), and the porosity (φ) of the holey silicon membrane. The responsivity reflected the gain of the detector or how sensitive the system responded to a thermal signal. The Noise equivalent power (NEP) was the minimum radiant flux measured by the detector per unit of bandwidth,

$$NEP = {V}_{noise} / {R}_{s} = \frac{1}{η} \sqrt{4 {k}_{B} {T}^{2} {G}_{th} ( ϕ )} \sqrt{1 + \frac{1 + {( 2 π f τ )}^{2}}{\overline{ZT}}} ,$$

where Z̅T̅ was the effective thermoelectric figure of merit of the thermal detector and k_{B} was the Stefan-Boltzmann constant.

There were two dominant contributions of NEP given by its equivalent form in terms of the noise spectral density,

$${S}_{noise} = \frac{NEP}{{R}_{s}} = \sqrt{{S}_{TF}^{2} + {S}_{Johnson}^{2}} ,$$

where S_{TF} was the phonon and photon noise due to temperature fluctuations across the thermal leg and S_{Johnson} was the electronic noise generated by thermal excitation of the charge carriers from equilibrium. The most important figure of merit proposed was the specific detectivity,

$${D}^{*} = \frac{\sqrt{A \cdot Δ f}}{NEP} = \frac{{R}_{s} \sqrt{A}}{{S}_{noise}} ,$$

which related to the absorber area, responsivity, and the noise spectral density. The higher the specific detectivity, the more responsive and sensitive the detector was. Based on these equations, reducing the thermal conductance, Gₜₕ(φ), was the most effective way to improve the performance of thermopiles. A reduction in the thermal conductance resulted in a higher responsivity and a lower NEP, translating to a higher specific detectivity.

Thermopile detectors were based on two signal transduction stages: radiation to thermal and thermal to electrical. In the first stage, the input radiation power was converted into heat by an absorber, which created a temperature gradient in a thermal isolation structure. In the second stage, this intermediate signal was converted into the electrical voltage signal using a temperature difference transducer,

$$Δ V = N ( {α}_{p} - {α}_{n} ) Δ T .$$

The incident radiant power density, which depended on the field of view (θ) and the distance (d) between the source and absorber, was given by the Stefan Boltzmann law of radiation,

$${φ}_{o} = σ ( {T}_{s}^{4} - {T}_{o}^{4} ) θ .$$

The amount of heat absorbed,

$${P}_{abs .} = {ηφ}_{o} {A}_{abs .} ,$$

diffused through the holey Si membranes into the surroundings, as indicated by the arrows.

To analytically determine the responsivity, the equivalent thermal conductance of the system was computed,

$${G}_{th} = {P}_{abs} / Δ T = {G}_{cond , struct .} + {G}_{cond , amb .} + {G}_{rad , o} ,$$

which summed up three major components: (1) conduction of the thermal isolation structure, including thermocouples (BiTe or doped Holey-Si) and silicon nitride (SiN) support beams (for conventional thermopile designs),

$${G}_{cond , struct .} = \sum ( {k}_{{eff}_{i}} {t}_{i} {w}_{i} ) / {l}_{i} ;$$

(2) conduction of the static ambient gas,

$${G}_{cond , amb .} = {w}_{abs .} {l}_{abs .} {k}_{gas} ( 1 / {d}_{1} + 1 / {d}_{2} ) ;$$

(3) radiation between the absorber and the surrounding at background/operating temperature

$${T}_{o} , {G}_{rad , o} \approx 4 {w}_{abs .} {l}_{abs .} \cdot εσ {T}_{o}^{3}$$

(assuming ΔT<<Tₒ). In order to calculate the thermal conductance of Holey Si, corrections on the effective thermal conductivity were applied,

$${k}_{eff} = ( \frac{1 - ϕ}{1 + ϕ} ) {k}_{holey Si} ,$$

due to the porosity effect [with a correction factor

$$( \frac{1 - ϕ}{1 + ϕ} )$$

given by effective medium theory] and the size effect at the micro- and nanoscales.

While the analytical model showed that the specific detectivity generally increases with decreasing thermal conductance, there were performance trade-offs between the thermal conductivity and electrical conductivity of the holey silicon-based thermopile detectors. While the responsivity (Rₛ) and the thermal noise (S_{TF}) of the detectors benefitted from the reduction of thermal conductance (due porosity effect and the size effect at the micro/nanoscale), the Johnson's noise

$${S}_{Johnson} = \sqrt{4 {k}_{B} {TR}_{elec .}} ,$$

increased as a result of increasing electrical resistance (e.g. porosity effect). In other words, the holey Si membrane needed to be optimized to balance the favorable contribution of responsivity and thermal noise from lower thermal conductance and the adverse retribution of noise from higher electrical resistance. There were several optimization approaches to achieve these goals: (1) the neck size of holey silicon needed to be sized larger than the electron mean free path (which was ~1 to 10 nm for highly dope silicon with a

$$concentration of ∼ 1 \times {10}^{19} {cm}^{- 3} )$$

so that the size effect on the electrical properties become negligible. (2) the doping concentration of holey silicon needed to be tuned to yield a high thermoelectric power factor, σα². (3) the geometry of the thermoelectric lines needed to be optimized according to the dimension of the absorber, which is application-dependent.

One of the unique advantages the holey silicon-based thermoelectric lines had over the Be—Te-based thermoelectric lines was that the holey silicon was complementary metal-oxide-semiconductor (CMOS) compatible. The proposed holey silicon structure was fabricated using electron-beam lithography and plasma etching process, and the thickness of the holey silicon membrane (device layer) was more precisely controlled compared to the co-evaporation of BiTe films onto SiN support beams. For instance, the analytic model showcased that a thicker holey silicon membrane effectively reduced the Johnson's noise (i.e. electrical resistance) without sacrificing much on the responsivity (i.e. thermal conductance). Further geometric optimization of the thermoelectric lines using the analytical model showed that the Holey Si-based thermopile can outperform the PREFIRE by a factor of 4.

While the predictions above were based on room temperature operation (300K), the performance of holey Si-based thermopiles at various operating temperatures (e.g. extremely cold environments) was equally important. In order to investigate the effect of background/operating temperature, Tₒ, on the specific detectivity, the temperature-dependent radiative thermal conductance

$$( {G}_{rad , o} ∝ {T}_{o}^{3} )$$

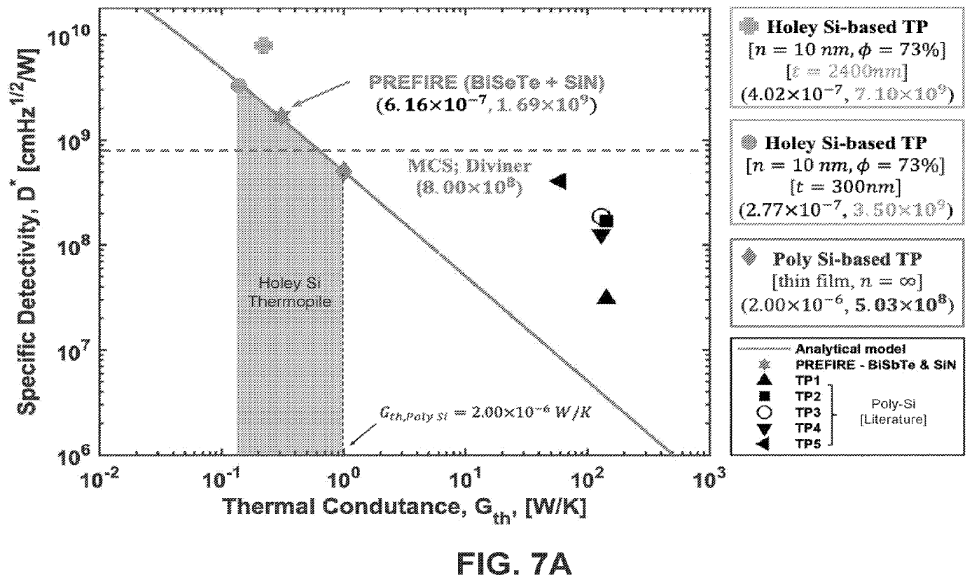

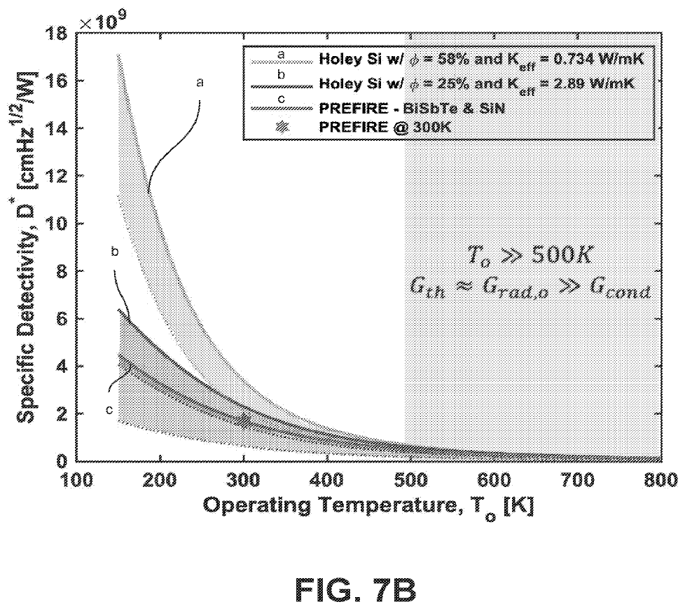

was evaluated and several assumptions were made on the temperature-dependent thermal conductivities of BiSbTe, SiN, and Holey-Si based on prior reported values. It was found that Holey Si-based thermopiles showed significant improvement in D* for T_{O}<300K. The improvement was more prominent at low temperature and at high porosity because the contribution from G_{rad,o} was small at low-temperature and G_{cond,TE} (e.g. using the porosity effect) was further reduced to the point where G_{rad,o} became dominant. As shown by curve a in FIG. 7B that corresponds to a holey silicon membrane with a porosity of 58%, the specific detectivity approached the background limit of 1.8×10¹⁰ as the temperature dropped to 150K. Nevertheless, for Tₒ>500K, the total thermal conductance was dominated by radiation, G_{th,total}≈G_{rad,o}>>G_{cond,TE}, and the reduction on G_{cond,TE} using holey cond,TE silicon played a negligible role in D improvement.

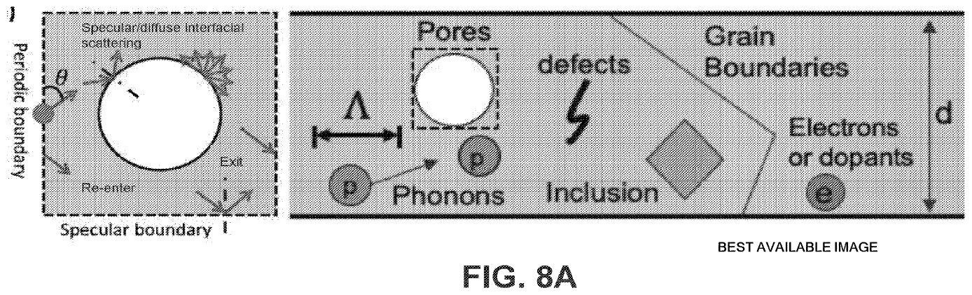

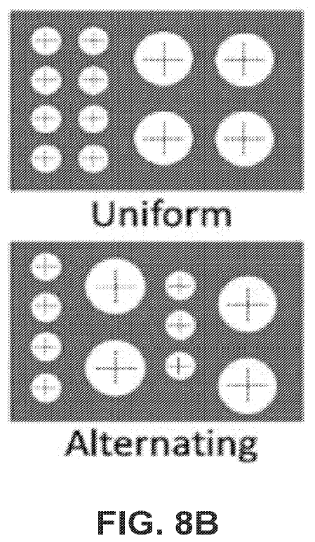

One of the fundamental challenges in understanding thermal transport mechanisms in holey silicon or nanoporous structures was with multi-dimensional phonon transport phenomena. Conventional models based on Boltzmann Transport Equation (BTE) were very useful for capturing isotropic thermal conduction and explaining size dependencies in simple films with uniform thicknesses and nanowires with uniform diameters. However, the simple BTE models did not account for multi-dimensional scattering events or shape-dependent transport in complex geometries. Therefore, the Monte Carlo ray tracing (MCRT) method was used. The ray tracing simulation tracked a three-dimensional transport path of individual phonons and fully accounted for boundary scattering events in complex geometries. The present invention leveraged holey silicon by building an extensive thermal conductivity database for holey silicon with various pore shapes and pore arrangements, as shown in FIG. 8B, and then using the predicted thermal properties to optimize the designs of thermoelectric lines.

The measurement of holey silicon was based on micro-fabricated membranes that were suspended from a substrate and thermally isolated from an environment. Two symmetric island structures were each equipped with Pt electrodes, which acted as a thermometer and a heater. For thermal transport characterization, one of the islands was heated and the bridged holey silicon membrane transported the heat by conduction to the other island under a high vacuum (<10e⁶ torr). During this process, the temperature of each membrane was monitored simultaneously. The temperature difference between the two islands was used to extract the thermal conductivity of the holey silicon membrane. A customized vacuum chamber system was used to control the measurement temperature in the range of 10-800 K. In addition, the sheet resistance and electrical resistivity of holey silicon was measured using the Ossila™ Four-Point Probe. The measurement used four probes arrayed in a line, with equal spacing between each probe. A current was passed between the outer two probes, causing a reduction in voltage between the inner two probes. By measuring this change in voltage, the sheet resistance was calculated given geometric factors accounting for the size, shape, and thickness of the sample.

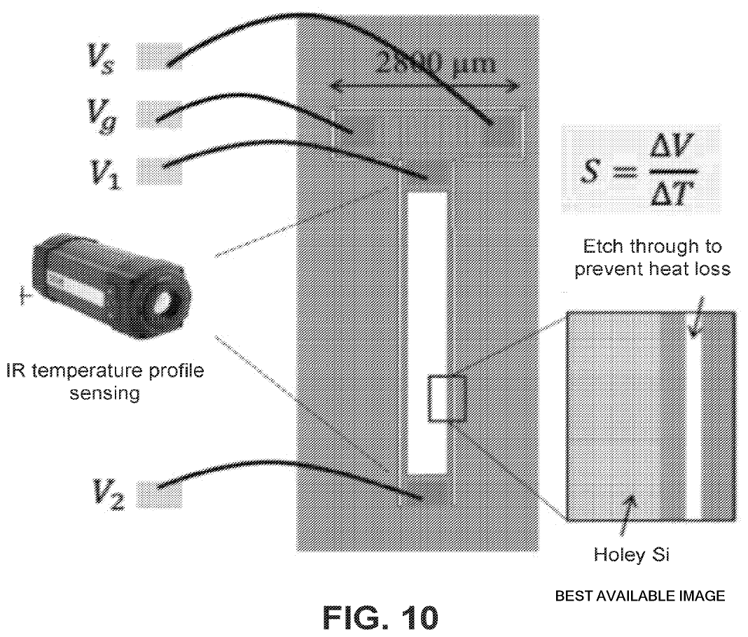

The Seebeck coefficient was measured using the suspended two-membrane structure shown in FIGS. 9A-9B and the on-substrate approach shown in FIG. 10. The holey silicon sample was fabricated, with a mask, on a silicon-on-insulator (SOI) wafer. A metal coil heater and two electrodes were deposited using e-beam vapor deposition. The coil heater was used to generate a temperature gradient across the sample while the two electrodes were used for voltage measurement. The temperature gradient was monitored by a high-resolution infrared (IR) camera, and the Seebeck coefficient of holey silicon was measured by a ratio of the voltage difference and the temperature difference, α=ΔV/ΔT.

During the testing phase, read-out integrated circuits (ROICs) from Black Forest Engineering™ were employed to characterize the devices. The holey silicon thermal detectors were required to have a form factor and pixel count compatible with four of these individual two-channel ROICs. The holey silicon devices were designed to be a drop-in component, and the detector array and ROICs were mounted onto a hybrid substrate and electrically connected by wire bonding. Each ROIC was comprised of 128 channels, including multiplexers on a chip that outputted 24-bit digitized signals on two wires. Additional wiring for clock, power, and serial peripheral interface (SPI) communications was added to the cabling requirement. The wired connections were bundled and shielded to avoid signal loss and noise pickup.

Detectivity from the pixel rows was measured to an absolute accuracy of ±2% at the nominal 290 K temperature of the blackbody calibration targets. The signal-to-noise performance of each pixel was compared with respect to prior thermopile-based detectors. It was noted that the detector array had a highly efficient coating called ‘gold-black’ that had near unity efficiency from 0.1 μm to 100 μm. The gold black absorber was deposited using the same dedicated thermal evaporator used for MCS/Diviner™. The gold black was patterned using a stencil fixture/deposition mask to be applied on top of the holey silicon detector prior to gold black deposition.

The computer system can include a desktop computer, a workstation computer, a laptop computer, a netbook computer, a tablet, a handheld computer (including a smartphone), a server, a supercomputer, a wearable computer (including a SmartWatch™), or the like and can include digital electronic circuitry, firmware, hardware, memory, a computer storage medium, a computer program, a processor (including a programmed processor), an imaging apparatus, wired/wireless communication components, or the like. The computing system may include a desktop computer with a screen, a tower, and components to connect the two. The tower can store digital images, numerical data, text data, or any other kind of data in binary form, hexadecimal form, octal form, or any other data format in the memory component. The data/images can also be stored in a server communicatively coupled to the computer system. The images can also be divided into a matrix of pixels, known as a bitmap that indicates a color for each pixel along the horizontal axis and the vertical axis. The pixels can include a digital value of one or more bits, defined by the bit depth. Each pixel may comprise three values, each value corresponding to a major color component (red, green, and blue). A size of each pixel in data can range from 8 bits to 24 bits. The network or a direct connection interconnects the imaging apparatus and the computer system.

The term “processor” encompasses all kinds of apparatus, devices, and machines for processing data, including by way of example a programmable microprocessor, a microcontroller comprising a microprocessor and a memory component, an embedded processor, a digital signal processor, a media processor, a computer, a system on a chip, or multiple ones, or combinations, of the foregoing. The apparatus can include special-purpose logic circuitry, e.g., an FPGA (field programmable gate array) or an ASIC (application-specific integrated circuit). Logic circuitry may comprise multiplexers, registers, arithmetic logic units (ALUs), computer memory, look-up tables, flip-flops (FF), wires, input blocks, output blocks, read-only memory, randomly accessible memory, electronically-erasable programmable read-only memory, flash memory, discrete gate or transistor logic, discrete hardware components, or any combination thereof. The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The processor may include one or more processors of any type, such as central processing units (CPUs), graphics processing units (GPUs), special-purpose signal or image processors, field-programmable gate arrays (FPGAs), tensor processing units (TPUs), and so forth.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, a data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, drives, or other storage devices). The operations described in this specification can be implemented as operations performed by a data processing apparatus on data stored on one or more computer-readable storage devices or received from other sources.

Program code embodied on a computer-readable medium may be transmitted using any appropriate medium, including but not limited to wireless, wireline, optical fiber cable, R.F, Bluetooth, storage media, computer buses, etc., or any suitable combination of the foregoing. Computer program code for carrying out operations for aspects of the present disclosure may be written in any combination of one or more programming languages, including an object oriented programming language such as Java, Smalltalk, C#, Ruby, or the like, conventional procedural programming languages, such as Pascal, FORTRAN, BASIC, or similar programming languages, programming languages that have both object-oriented and procedural aspects, such as the “C” programming language, C++, Python, or the like, conventional functional programming languages such as Scheme, Common Lisp, Elixir, or the like, conventional scripting programming languages such as PHP, Perl, Javascript, or the like, or conventional logic programming languages such as PROLOG, ASAP, Datalog, or the like.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. To provide for interaction with a user, embodiments of the subject matter described in this specification can be implemented on a computer having a display device, e.g., an LCD (liquid crystal display), LED (light emitting diode) display, or OLED (organic light emitting diode) display, for displaying information to the user.

Examples of input devices include a keyboard, cursor control devices (e.g., a mouse or a trackball), a microphone, a scanner, and so forth, wherein the user can provide input to the computer. Other kinds of devices can be used to provide for interaction with a user as well; for example, feedback provided to the user can be in any form of sensory feedback, e.g., visual feedback, auditory feedback, or tactile feedback; and input from the user can be received in any form, including acoustic, speech, or tactile input. Examples of output devices include a display device (e.g., a monitor or projector), speakers, a printer, a network card, and so forth. Display devices may include display devices that provide visual information, this information typically may be logically and/or physically organized as an array of pixels. In addition, a computer can interact with a user by sending documents to and receiving documents from a device that is used by the user; for example, by sending web pages to a web browser on a user's client device in response to requests received from the web browser.

An interface controller may also be included that may comprise any of a variety of known or future software programs for providing input and output interfaces. For example, interfaces may include what are generally referred to as “Graphical User Interfaces” (often referred to as GUI's) that provide one or more graphical representations to a user. Interfaces are typically enabled to accept user inputs using means of selection or input known to those of ordinary skill in the related art. In some implementations, the interface may be a touch screen that can be used to display information and receive input from a user. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft® Windows Powershell that employs object-oriented type programming architectures such as the Microsoft®.NET framework.

Those of ordinary skill in the related art will appreciate that interfaces may include one or more GUI's, CLI's or a combination thereof. A processor may include a commercially available processor such as a Celeron, Core, or Pentium processor made by Intel Corporation®, a SPARC processor made by Sun Microsystems®, an Athlon, Sempron, Phenom, or Opteron processor made by AMD Corporation®, or it may be one of other processors that are or will become available. Some embodiments of a processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related field will appreciate that a processor may be configured in what is generally referred to as 32 or 64 bit architectures, or other architectural configurations now known or that may be developed in the future.

A processor typically executes an operating system, which may be, for example, a Windows type operating system from the Microsoft Corporation®; the Mac OS X operating system from Apple Computer Corp.®; a Unix® or LinuxR-type operating system available from many vendors or what is referred to as an open source; another or a future operating system; or some combination thereof. An operating system interfaces with firmware and hardware in a well-known manner, and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, and communication control and related services, all in accordance with known techniques.

Connecting components may be properly termed as computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A holey silicon-based thermopile (100) for temperature measurement across an entire electromagnetic spectrum, the thermopile (100) comprising:
a. a substrate (110), wherein a cavity (115) is formed by a shape of the substrate (110);
b. a thermally isolated absorber (120) disposed over the cavity (115) of the substrate (110), configured to accept an input radiation reading and output a heat signal;
c. an array of thermocouples (130) configured to connect the thermally isolated absorber (120) to the substrate (110), the array of thermocouples (130) comprising a plurality of silicon structures, each silicon structure having a hole pattern comprising a plurality of holes disposed through the silicon structure;
wherein the thermally isolated absorber (120) is suspended over the cavity (115) by the array of thermocouples (130); and
d. a temperature difference transducer (140) operatively coupled to the thermally isolated absorber (120), configured to convert the heat signal into an electrical voltage signal.

2. The thermopile (100) of claim 1, wherein the hole pattern of each silicon structure comprises a uniform pattern such that the plurality of holes are grouped by a diameter of each hole.

3. The thermopile (100) of claim 1, wherein the hole pattern of each silicon structure comprises an alternating pattern having a first set of holes and a second set of holes interdigitatably disposed between the first set of holes, wherein the first set of holes and the second set of holes differ in diameter.

4. The thermopile (100) of claim 1, wherein the plurality of holes comprise a circular shape, a rectangular shape, an ellipsoid shape, a diamond shape, a meniscus shape, or a combination thereof.

5. The thermopile (100) of claim 1, wherein a material of the substrate (110) comprises silicon, silicon dioxide, or a combination thereof.

6. The thermopile (100) of claim 1, wherein the thermally isolated absorber (120) comprises a surface absorber.

7. The thermopile (100) of claim 1, wherein the thermally isolated absorber (120) comprises a volume absorber.

8. The thermopile (100) of claim 1 further comprising a computing device communicatively coupled to the temperature difference transducer (140), configured to accept the electrical voltage signal generated by the temperature difference transducer (140) and measure the electrical voltage signal.

9. A holey silicon-based thermopile (100) for temperature measurement across an entire electromagnetic spectrum, the thermopile (100) comprising:
a. a thermally isolated absorber (120) disposed over a cavity (115), configured to accept an input radiation reading and output a heat signal;
b. one or more thermocouples (130) coupled to the thermally isolated absorber (120), the one or more thermocouples (130) comprising one or more structures, each structure having a hole pattern comprising a plurality of holes disposed through the structure;
wherein the thermally isolated absorber (120) is suspended over the cavity (115) by the array of thermocouples (130); and
c. a temperature difference transducer (140) operatively coupled to the thermally isolated absorber (120), configured to convert the heat signal into an electrical voltage signal.

10. The thermopile (100) of claim 9, wherein the hole pattern of each structure comprises a uniform pattern such that the plurality of holes are grouped by a diameter of each hole.

11. The thermopile (100) of claim 9, wherein the hole pattern of each structure comprises an alternating pattern having a first set of holes and a second set of holes interdigitatably disposed between the first set of holes, wherein the first set of holes and the second set of holes differ in diameter.

12. The thermopile (100) of claim 9, wherein the plurality of holes comprise a circular shape, a rectangular shape, an ellipsoid shape, a diamond shape, a meniscus shape, or a combination thereof.

13. The thermopile (100) of claim 9, wherein the thermally isolated absorber (120) comprises a surface absorber.

14. The thermopile (100) of claim 9, wherein the thermally isolated absorber (120) comprises a volume absorber.

15. A holey silicon-based thermopile (100) for temperature measurement across an entire electromagnetic spectrum, the thermopile (100) comprising:
a. a substrate (110), wherein a cavity (115) is formed by a shape of the substrate (110);
b. a thermally isolated absorber (120) disposed over the cavity (115) of the substrate (110), configured to accept an input radiation reading and output a heat signal;
c. an array of thermocouples (130) configured to connect the thermally isolated absorber (120) to the substrate (110), the array of thermocouples (130) comprising a plurality of silicon structures, each silicon structure having a hole pattern comprising a plurality of holes disposed through the silicon structure;
wherein the plurality of holes comprise a circular shape, a rectangular shape, an ellipsoid shape, a diamond shape, a meniscus shape, or a combination thereof
wherein the thermally isolated absorber (120) is suspended over the cavity (115) by the array of thermocouples (130);
d. a temperature difference transducer (140) operatively coupled to the thermally isolated absorber (120), configured to convert the heat signal into an electrical voltage signal; and
e. a computing device communicatively coupled to the temperature difference transducer (140), configured to accept the electrical voltage signal generated by the temperature difference transducer (140) and measure the electrical voltage signal.
